(19) United States
(12) Patent Application Publication
(10) Pub. No.: US 2003/0081264 A1
(43) Pub. Date: May 1, 2003

(54) Image reading apparatus

(75) Inventors: Toshiya Kumano, Uji-shi (JP); Toshiharu Fukuma, Mishima-gun (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/279,582

(22) Filed: Oct. 24, 2002

(30) Foreign Application Priority Data
Oct. 31, 2001 (JP) 2001-335549

(51) Int. Cl. H04N 1/40

(52) U.S. Cl. 358/461

(57) ABSTRACT

An image reading apparatus includes a light source, a white basis plate, a first white basis data acquisition device that acquires a white basis data W1 by reading the white basis plate, with the light source that is fully cooled on, and a second white basis data acquisition device that acquires a white basis data W2 by reading the white basis plate with the light source on just before starting to read a first page of a document. The image reading apparatus also includes a compensation data acquisition device that acquires a compensation data K, based on the white basis data W1 and the white basis data W2 and a shading compensation device that outputs compensation image data P2 by compensating for a shading effect of each page of an image data P1 that is acquired by reading each page of the document, based on black basis data B, the white basis data W1, and the compensation data K acquired in advance.

### BACKGROUND OF THE INVENTION

1. Field of the Invention

The present invention relates to an image reading apparatus equipped with a facsimile machine and a copying machine. More particularly, the present invention relates to an image reading apparatus that is capable of preventing the density difference of image data, resulting from light volume fluctuation of a cold cathode tube that is used as a light source for reading documents.

2. Description of the Related Art

The image reading apparatus, equipped with a facsimile machine and a copying machine, implements a shading compensation. The shading compensation is a compensation process for reducing a density difference of each picture element resulting from a sensitivity difference in each picture element of CCD (Charged Coupled Device), a distortion of a focus lens that focuses incoming light. In the shading compensation, compensation image data P2 is acquired based on the following formula (1), using black basis data B, white basis data W and image data P1. The image data P1 is the digital data created by converting an analog signal outputted from each picture element of the CCD with an analog/digital converter (A/D converter).

P2=(P1−B)/(W−B)×(2ⁿ−1) . . . (1)

Herein, the code n is a process bit number (bit number of the A/D converter).

The black basis data B is created by converting the analog signal outputted from each picture element of the CCD into the digital data when reading an inky black basis image. More specifically, the black basis data B is acquired by reading with the light off.

Moreover, the white basis data W is made by converting the analog signal outputted from each picture element of the CCD into the digital data in reading a pure white basis image. More specifically, the white basis data W is acquired by reading a white basis plate prepared in advance with the light on.

The shading compensation process is used for obtaining the compensation image data P2 by compensating the image data P1 acquired in reading documents based on the above formula (1) using the white basis data W and the black basis data B of each picture element of the CCD as described above.

The conventional shading compensation as described above has the following problems. A cold cathode tube, commonly used as the light source, has characteristics of reducing the light volume when the temperature of the cathode tube rises. Thus, the light volume and the output signal level of the CCD may be reduced with the light on for hours when reading many pages of document continuously. However, the black basis data B and the white basis data W are not acquired every time each page of the document is read in the conventional shading compensation process, even if reading many pages of the document continuously. In other words, the data on each page of the document that is read continuously is compensated in the same way using the black basis data B and the white basis data W acquired in advance. Therefore, the compensation can be made preferably in constant light volume. However, the compensation cannot be made preferably as the light volume is reduced in reading plural pages of the document continuously. Thus, the quality of the read image data becomes deteriorated and the image looks dark. In other words, there is a problem of the density difference occurring every time each page of the document is read.

On the other hand, it is presumable that the above problem can be solved if the black basis image and the white basis image, read every time when each page of document is read, are compensated for the shading effect in every page using the acquired black basis data B and the white basis data W. In the conventional shading compensation, the black basis image and the white basis image are read over entirely in the width direction of the document, and additionally regarding a plurality of lines for removing noise effect. Their mean are then calculated, and it becomes the black basis data B and the white basis data W. Therefore, it takes much time to read many pages of the document if these processes are made on every page, and it is difficult to take in the shading data of every page.

It is an advantage of the present invention to provide the image reading apparatus, which is capable of optionally compensating for the shading effect, even when a cold cathode tube is used as a light source.

### SUMMARY OF THE INVENTION

An image reading apparatus of the present invention includes a light source, a white basis plate, a first white basis data acquisition device that acquires white basis data W1 by reading the white basis plate with the light that is fully cooled on, a second white basis data acquisition device that acquires a white basis data W2 by reading the white basis plate with the light on just before starting to read a first page of a document, a compensation data acquisition device that acquires compensation data K using the white basis data W1 and the white basis data W2, and a shading compensation device that compensates for the shading effect of each page of image data P1 acquired by reading the document and outputs compensation image data P2 using a black basis data B, the white basis data W1, and the compensation data K are acquired in advance.

In the image reading apparatus, the compensation data acquisition device acquires the compensation data K, based on a peak W1P of the white basis data W1 and a peak W2P of the white basis data W2.

The image reading apparatus of the present invention includes a compensation table that sets the relation between a basis compensation value X and the compensation data K. Herein, the compensation data acquisition device acquires the compensation data K based on the compensation table and the basis compensation value X acquired by subtracting the white peak W2P from the white peak W1P.

In the image reading apparatus of the present invention, the compensation table sets the relation between an elapsed time from the start of putting on the light source and the value of the compensation data K. The compensation data acquisition device acquires the compensation data K based on an elapsed time T until just before starting to read each page of the document and the compensation table.

In the image reading apparatus of the present invention, if the time corresponding to the elapsed time T is not included in the compensation table, the compensation data acquisition device acquires the compensation data K of the nearest time from the compensation table.

In the image reading apparatus of the present invention, the first white basis data acquisition device reads the white basis plate in the state of illuminating the light source that is fully cooled more than once, and the mean of each picture elements is made to be the white basis data W1.

In the image reading apparatus of the present invention, the first white basis data acquisition device reads the white basis plate in the state of lighting the light source that is fully cooled, throughout the reading width.

In the image reading apparatus of the present invention, the second white basis data acquisition device reads the white basis plate in a certain range of the entire reading width.

In the image reading apparatus of the present invention, the certain range is a central part of the entire reading width.

In the image reading apparatus of the present invention, the compensation data acquisition devices compensates the compensation data K more in a certain range of picture elements, according to the ratio of the white basis data W1 in each picture element and the black basis data B in each picture element, and the compensation data in each picture element other than the certain range is created.

In the image reading apparatus of the present invention, the light is a cold cathode tube.

In the image reading apparatus of the present invention, the shading compensation device implements the shading compensation according to the following formula:

P2=(P1−B )/I{(W+K)−B}×(2ⁿ−1)

where n is the process bit number, and the K is a value less than zero.

In the image reading apparatus of the present invention, the mean W1A of the white basis data W1 is used instead of the white peak W1P, and the mean W2A of the white basis data W2 is used instead of the white peak W2P.

The image reading apparatus of the present invention includes a light source, a white basis plate, a first white basis data acquisition device that acquires a white basis data W1 by reading the white basis plate with the light that is fully cooled on, a second white basis data acquisition device that acquires a white basis data W2 by reading the white basis plate with the light on just before starting to read each page of the document, a compensation data acquisition device that acquires the compensation data K based on the white basis data W1 and the white basis data W2, and a shading compensation device that that compensates for the shading effect of each page of the image data P1 acquired by reading the document based on the black basis data B, the white basis data W1, and the compensation data K acquired in advance and outputs a compensation image data P2.

Moreover, in the image reading apparatus of the present invention, the compensation data acquisition device sets a difference value W which is the difference between the peak value W1P and the peak W2P to the compensation data K.

The image reading apparatus of the present invention acquires the compensation data based on the white basis data acquired by reading the white basis data just before starting to read the document, and compensates for the shading effect of each page of the image data acquired by reading the document with the compensation data. Furthermore, a document includes a plurality of pages.

The image reading apparatus of the present invention has the effect of reducing the density difference in each picture element of the image data. Furthermore, the image reading apparatus of the present invention is capable of suitably compensating for the shading effect depending on the light volume just before starting to read each page of the document, reflecting the reduction of the light volume by raising the temperature accompanied with the light on, if the cold cathode tube is used as the light source. Moreover, since the image reading apparatus acquires the compensation data K in a short process time and compensates for the shading effect using the compensation data K, the compensation can be made without making the process time longer, though the shading compensation is made by using a different value so as to suitably compensate each document.

### BRIEF DESCRIPTION OF THE DRAWINGS

FIG. 1 is a cross sectional view of showing a copying and facsimile composite machine equipped with an image reading apparatus in a preferred embodiment of the present invention.

FIG. 2 is an enlarged cross sectional view around a document reading part of the image reading apparatus in the preferred embodiment of the present invention.

FIG. 3 is a block diagram of showing an electrical configuration of the copying and facsimile composite machine equipped the image reading apparatus in the preferred embodiment of the present invention.

FIG. 4 is a diagram for explaining a first acquisition method of a compensation data K in the image reading apparatus in the preferred embodiment of the present invention. More specifically, it is a diagram that the output value of each picture element of the CCD in the document reading part is shown throughout the reading width.

FIG. 5 is a diagram of showing an example of the compensation table used in the first acquisition method of the compensation data K in the image reading apparatus in the preferred embodiment of the present invention.

FIG. 6 is a diagram for explaining a second acquisition method of the compensation data K in the image reading apparatus in the preferred embodiment of the present invention. More specifically, it is a diagram that the output value of each picture element of the CCD in the document reading part is shown throughout the reading width.

FIG. 7 is a diagram for explaining the acquisition method of the compensation data K in the image reading apparatus in the preferred embodiment of the present invention. More specifically, it is a diagram of showing the case that a second white basis data W2 can be acquired only from the output value of each picture element in the vicinity of both ends part of the reading width in the document reading part.

### DETAILED DESCRIPTION OF THE INVENTION

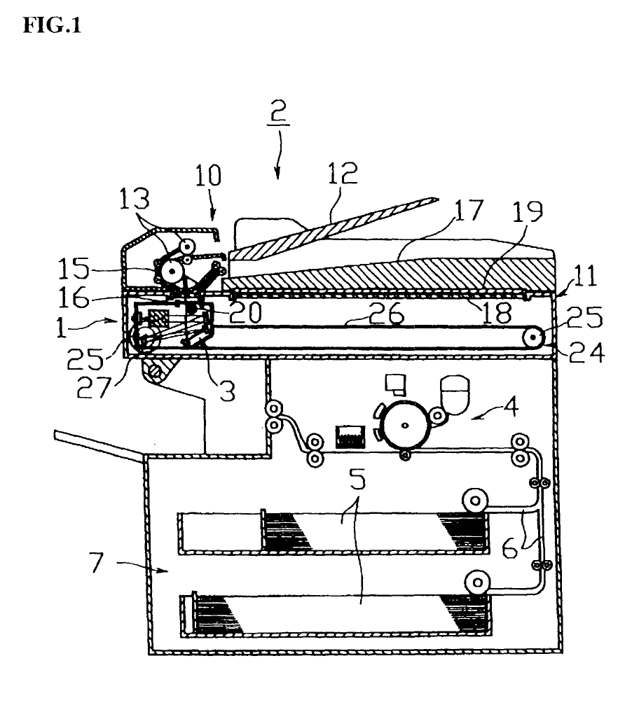

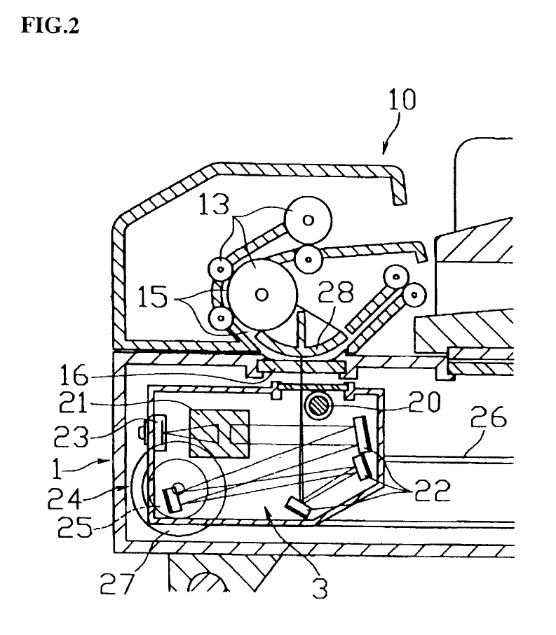

Hereinafter, an image reading apparatus 1 in a preferred embodiment of the present invention will be described with reference to drawings. FIG. 1 is a cross sectional view of showing a copying and facsimile composite machine 2 equipped with the image reading apparatus 1. FIG. 2 is an enlarged cross sectional view around a document reading unit 3 of the image reading apparatus 1.

The copying and facsimile composite machine 2 includes the image reading apparatus 1, a recording apparatus 7, a MODEM 8 and a network control unit (NCU) 9. The recording apparatus 7 includes a recording unit 4, a recording paper storage unit 5, and a recording paper feed path 6. The recording unit 4 records image data read by the image reading apparatus 1, on the recording paper. The recording paper storage unit 5 stores recording papers. The recording paper feed path 6 feeds the recording paper from the recording paper storage unit 5 to the recording unit 4. The MODEM 8 and the NCU 9 transmit or receive image data. The image reading apparatus 1 can be used with any apparatus that can read document image as digital data, and may also be applied to a facsimile machine, a copying machine and an image scanner that is capable of being connected to personal computers.

The image reading apparatus 1 includes the document reading unit 3, an automatic document feeder (ADF) 10, and a flat bed 11.

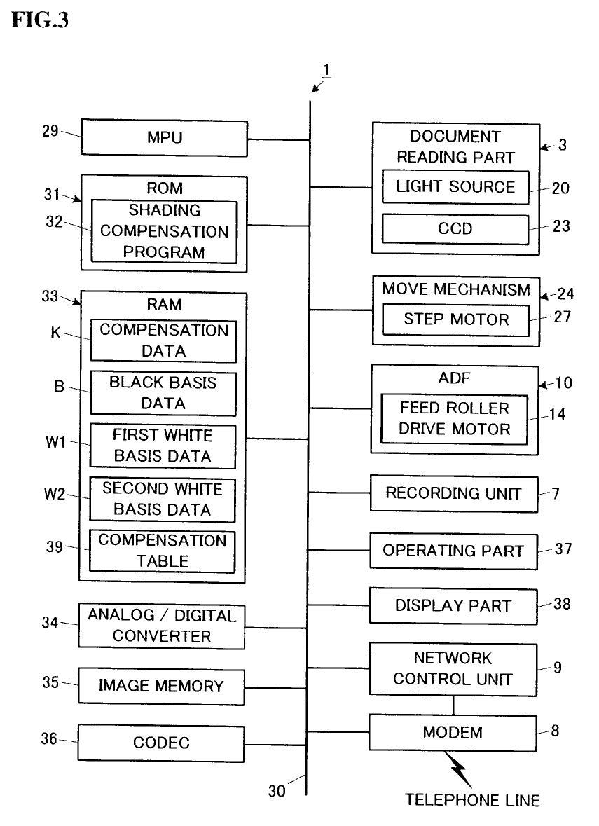

Herein, the ADF 10 includes a document supply tray 12, a feed roller 13, a feed roller drive motor 14, a document feed path 15, a platen glass 16, and a document discharge tray 17. A plurality of pages of a document to be read is placed on the document supply tray 12. The feed roller 13 picks up one page from the document and feeds the pages one by one. The feed roller drives motor 14 drives the feed roller 13 (see FIG. 3). The document feed path is a path for feeding documents. The platen glass 16 is a transparent plate, and is located at the lowest part of the document feed path 15. The document discharge tray 17, on which documents are discharged after reading, is located in the end of the document feed path 15. The image in the document to be fed on the document feed path 15 is read by the document reading part 3 that is stopped in a predetermined position below, when passing through the upper surface of the platen glass 16.

The flat bed 11 includes a platen glass 18 and a press cover 19. The platen glass 18 is a transparent plate, and the document is placed on the upper surface. The press cover 19, formed in one with the ADF 10, presses the document on the upper surface of the platen glass 18 from above. The image of the document placed on the platen glass 18 is read by the document reading unit 3 that moves below the platen glass 18.

As illustrated in FIG. 2, the document reading unit 3 includes a light source 20, a plurality of mirrors 22, a focus lens 21, and CCD 23. A cold cathode tube is used as the light source 20, which gives light to the document passing on the upper surface of the platen glass 16 or the document placed on the upper surface of the platen glass 18. The mirrors 18 changes the direction of reflected light from documents to the focus lens 21. The focus lens 21 focuses the incoming light on the CCD 23. The CCD 23 converts the image focused by the focus lens 21 into an electronic signal and outputs it.

The document reading unit 3 is used for reading documents in both the ADF 10 and the flat bed 11. Thus, as illustrated in FIG. 1, the document reading unit 3 is properly moved back and forth horizontally along the platen glass 18 by a move mechanism 24. Hereupon, in this “Detailed Description of the Invention”, the left side is regarded as the front and the right side as the back in FIG. 1.

The move mechanism 24 includes a pair of front and rear pulleys 25, a drive belt 26 that is wound around these pulleys, and a step motor 27 for moving the document reading unit 3 to a predetermined position by rotating either pulley 25 a predetermined amount.

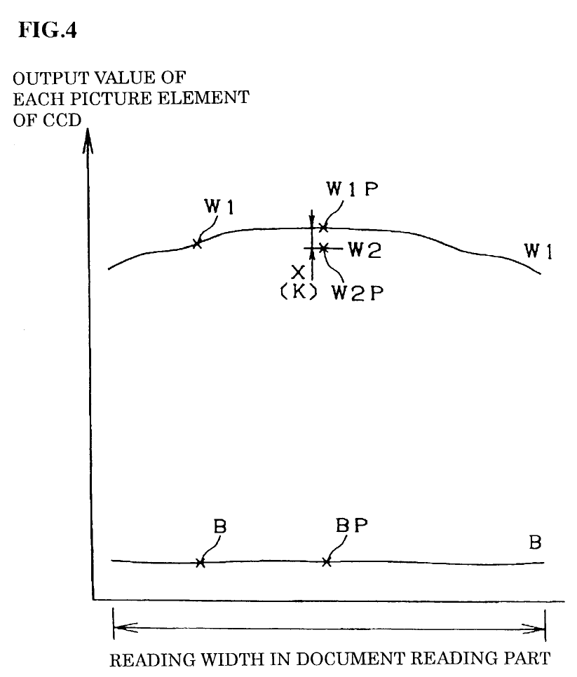

Moreover, as illustrated in FIG. 2, a white basis plate 28 is disposed above the platen glass 16 in the document feed path 15 of the ADF 10. The white basis plate 28 is the plate shape member for acquiring a first white basis data W1 and a second white basis data W2 (see FIG. 3 and FIG. 4), used in the shading compensation by reading them in the document reading unit 3. Thus, it is white color that becomes the basis and is formed by a material such as synthetic resin that is difficult to attach a stain.

It is preferable that the white basis plate 28 is disposed so as to be almost the same height as one of the upper surfaces of the platen glasses 16 and 18, in order to read the white basis plate 28 on almost the same condition as reading the document. Therefore, the white basis plate 28 is formed in one with the member including the document feed path 15 of the ADF 10. The white basis plate 28 is then disposed in the position contacting the upper surface of the platen 16. Additionally, the position of the white basis plate 28 is not limited in the above-mentioned position, and it can be disposed in the other position. Moreover, the number is not confined to one, and a plurality of white basis plates 28 can be also disposed.

Next, the electrical configuration of the copying and facsimile composite machine 2 will be described. FIG. 3 is a block diagram showing an electrical configuration of the copying and facsimile composite machine 2.

A MPU (Micro Processing Unit) 29 is connected to the respective parts including the copying and facsimile composite machine 2 through a bus 30, and controls each part and processes for the shading compensation.

A ROM (Read Only Memory) 31 stores various programs necessary for the operation of the MPU 29, and also stores a shading compensation program 32.

A RAM (Random Access Memory) 33 stores various data temporarily, acquired by operating the copying and facsimile composite machine 2. Additionally, the RAM 33 stores compensation data K, the black basis data B, the first white basis data W1, the second white basis data W2 used for the shading compensation, and the compensation table 39.

An analog/digital converter 34 (A/D converter 34) converts an analog signal outputted from the CCD 23 in the document reading part 3 into digital data.

The document reading unit 3, includes the light source 20 and the CCD 23, reads the document image based on the operation signal from the MPU 29, and outputs the analog signal.

The move mechanism 24 actuates the step motor 27 to move the document reading unit 3, based on the operation signal from the MPU 29.

The ADF 10 actuates the feed roller drive motor 14 to feed the document one by one, based on the operation signal from the MPU 29.

The recording apparatus 7 is provided for recording the document image on the recording paper.

An image memory 35 is provided for storing image data and received image data temporarily.

A CODEC (Coder and Decoder) 36 encodes and decodes the image data for transmitting and receiving by facsimile.

The modem 8 and the network control unit (NCU) 9 are communication control devices for transmitting and receiving by facsimile.

An operating part 37 is equipped with various operating keys for operating the copying and facsimile composite machine 2.

A display part 38 is equipped with a display panel and an indicating lamp that indicate an operating condition of the copying and facsimile composite machine 2 and various setting conditions.

Next, the shading compensation process made by the image reading apparatus 1 will be described.

The image reading apparatus 1 is characterized by acquiring a compensation data K just before starting to read each page of the document, and by compensating for the shading effect of each page of an image data P1 acquired by reading a document, using the compensation data K.

The shading compensation process will be described in detail. First, the compensation data K is acquired based on a first white peak W1P and the second white peak W2P. The first white peak W1P is a maximum of a first white basis data. The first white basis data is acquired by reading the white basis plate 28 with the light fully cooled. The second white peak W2P is a maximum of the second white basis data. The second white basis data W2 is acquired by reading the white basis plate 28, just before starting to read each document. Next, the shading compensation is made on each page of the image data P1 acquired by reading the document, based on a black basis data B acquired in advance, the first white basis data W1, and the compensation data K. Thus, a compensation image data P2 is outputted.

The compensation image data P2 is calculated based on the following formula (2). The code n is a process bit number by the A/D converter 34. Moreover, the code K may take a value less than zero.

P2=(P1−B)/{(W1+K)−B}×(2ⁿ−1) . . . (2)

Here, the compensation image data P2 is calculated respectively in every picture element of the CCD 23. Thus, the image data P1 in every picture element, and the white basis data, the black basis data, and the compensation data K corresponding to each picture element, are respectively substituted in the above formula (2).

The first white basis data W1 is acquired by converting the analog signal into the digital data by the A/D converter 34. Its analog signal is outputted from the respective picture element of CCD 23, when reading the white basis plate 28 with the light source 20 fully cooled on. More specifically, the first white basis data W1 is the white basis data when the light volume of the light source 20 is the maximum before the light volume is reduced resulting for raising the temperature of the light 20. Thus, it is the basis data for compensating the density difference of each picture element of image data P1, and is used by substituting in the above formula (2).

Furthermore, as illustrated in FIG. 4, the first white basis data W1 is acquired by reading the entire reading width of the document reading unit 3 for acquiring the output value of the entire picture elements of the CCD 23. Moreover, a plurality of lines is read for removing noise effects, and the mean of a plurality of lines on each picture element is adopted as the first white basis data W1. In addition, FIG. 4 is a diagram that shows the output of the first white basis data W1, the second white basis data W2, and the black basis data B throughout the entire width.

As described later, the second white basis data W2 is acquired by converting an analog signal into the digital data by A/D converter 34. The analog signal is outputted from the respective picture elements of the CCD 23 in reading the white basis plate 28 with the light source on just before staring to read the first page of the documents that consists of one page or plural pages or just before starting to read each page of the document that consists of one page or plural pages.

The timing of acquiring the second white basis data W2, only just before starting to read the first page of the document or just before reading each page of the document, differs according to an acquisition method of the compensation data K as described later.

The second white basis data W2 can be acquired when the volume of the light source 20 is same as the one in reading documents. If the temperature of the light source 20 has already risen, the second white basis data 20 becomes the white basis data with reducing the light volume by the rise of temperature. The second white basis data W2 is provided for acquiring the second white peak W2P. Thus, there is no need to acquire the output value on all picture elements of the CCD 23, and it is enough to acquire the output value only on a predetermined range of picture elements. Therefore, as illustrated in FIG. 4, the region only on the predetermined range in the entire width of the document reading unit 3 is read. Here, each picture element in the vicinity of the central part of the reading width in the document unit 3 that the curve of the output value is almost horizontal is set as a predetermined range of the second white basis data W2.

The black basis data B is acquired by converting the analog signal outputted from each picture element in reading the inky black basis image into the digital data. For example, it may be acquired by reading with the light source 20 off.

The black basis data B is the basis data in compensating for the shading effect used by substituting the data into the above formula (2). In other words, it is the basis data of compensating the density difference of each picture element of the image data. Therefore, as illustrated in FIG. 4, the black basis data B is acquired by reading the entire width of the document reading unit 3 for acquiring the output of the entire picture element of CCD 23. Moreover, a plurality of lines is read for removing noise effects, and the mean of a plurality of lines on each picture element is adopted as the black basis data B.

The compensation data K is the data acquired based on the first white peak W1P and the second white peak W2P. The compensation data K solves the problem that the light volume is reduced resulting from the temperature rise of the light source 20 with the light on continually. And it is used for compensating the density difference of the image data occurred by darkening the image quality of the read image data, accompanied by reducing the light volume of the light 20.

The compensation data K is used by substituting into the above formula (2). In other words, the first white basis data W1 when the volume of the light is the maximum is added to the compensation data K that is under zero. In this way, the first white basis data W1 is compensated with reducing the volume of the light 20. The compensation data K corresponds to the value that minuses the first white basis data W1 when the light volume is the maximum with fully cooling the light 20, from the white basis data when the light volume of the light 20 is reduced in the state of actually reading each page of the document in every picture element of the CCD 23. Therefore, the compensation data K surely becomes less than zero.

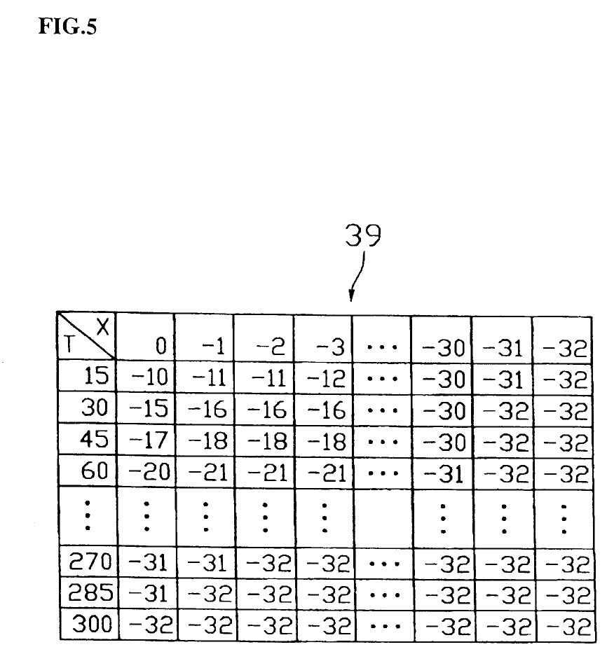

The following two methods may be considered for acquiring the compensation data K. As illustrated in FIG. 4, the first method is that the difference W2P−W1P that minuses the first white peak W1P from the second white peak W2P is provided as a basis compensation value X (X=W2P−W1P, X≦0). Then, the suitable compensation data K is acquired for using the shading compensation in every page of the document, based on the basis compensation value X and the compensation table 39 (see FIG. 5). The compensation table 39 sets the compensation data K after a predetermined time corresponding to the basis compensation value X.

Here, the second white peak W2P adopts an output value of the picture element whose value is the largest in each picture element of the second white basis data W2 acquired by reading only a predetermined range in the reading width of the document reading part 3. Moreover, the first white peak W1P adopts the output value of the picture element whose value is the largest in the output value of each picture element in a predetermined range corresponding to the range that is read for acquiring the second white basis data W2. As described above, regarding the second white peak W2P and the first peak W1P, the process time can be faster by taking the peak from a predetermined range, not from the whole document reading width. Moreover, the noise effect can also be removed by comparing the peak value in a predetermined range, not comparing only a value of a specific picture element.

The basis compensation value X indicates the value corresponding to the amount that reduces the light volume of the light 20 source just before starting to read the first page of the document, on the basis of the maximum light volume with fully cooling the light source 20, regarding the output of a predetermined range of picture elements in the reading width of the document reading unit 3. Therefore, regarding the predetermined range of the picture elements of the CCD 23, the compensation data K, used in the shading compensation to the image data P1 in the first page of the document, can be made to be the basis compensation value X (K=X).

On the other hand, as illustrated in FIG. 4, it is known that the first white basis data W1 in the both ends becomes smaller because of the distortion of lens. Therefore, the compensation data on each picture element other than the predetermined range of the CCD 23 is acquired by compensating the compensation data K on the predetermined range of the picture elements more, according to the curve of the first white basis data W1. In other words, a compensation value K′, which the compensation data K in the predetermined range of the picture elements is compensated more, is made to be the compensation data other than a predetermined range, according to a dynamic range W1/B that is the ratio of the first white basis data W1 and the black basis data B in each picture element. Here, in the case that a code W1′ is set to the first white basis data in each picture element other than the predetermined range, a code B′ is set to the black basis data of the picture element corresponding to the code W1′, and a code BP is set to the black basis data of the picture element corresponding to the first white peak value W1P, the code K′ is calculated based on the following formula (3).

K′=K×(W1′/B′)/(W1P/BP) . . . (3)

It is preferable that the process is as simple as possible, as the process of calculating the compensation data K′ from the compensation data K in a predetermined range of the picture element as described above is needed in every page, following the second page. Consequently, the black basis data B is regarded to be constant in every picture element, because of the value of the black basis data B is not almost fluctuated. In order to speed up the process speed by making the process of calculating the code K′ easier, and the code K′ can be also calculated based on the following formula (4).

K′=K×W1′/W1P . . . (4)

Additionally, a constant compensation data K may be used in the whole picture element of the reading width in the document reading unit 3 without compensating the value of the compensation data K according to the curve of the first white basis data W1, for simplifying and speeding up further processes.

Hereinafter, for making the explanation easier, only the compensation data K in the predetermined range of the picture element of the CCD 23 will be described, regarding the compensation data used in the shading compensation to the image data P1, following the second page. However, the compensation data K in the picture element other than a predetermined range is acquired by compensating in the above method according to the curve of the first white basis data W1 all in the same way. Additionally, for further process simplification and speeding up, certain compensation data K may be used in the whole picture element of the CCD 23 without compensating the value of the compensation data K according to the curve of the first while basis data W1.

The compensation data K used in the shading compensation following the second page of the document is acquired from the compensation table 39, based on the basis compensation value X and the elapsed time T from the time of acquiring the basis compensation value X to the time of starting to read the page of the document. As illustrated in FIG. 5, the compensation table 39 is provided for setting the suitable compensation data K corresponding to the basis compensation value X and the elapsed time T. The value found by the experiment is used as the value of the compensation data K set in the compensation table 39.

In regard to the compensation table 39, the part such that the value of the compensation data K is under −32 is not existed, as the volume of the light source 20 becomes constant when time has elapsed for long hours.

Thus, if the elapsed time T is more than 300 seconds, the constant value of −32 is used in all compensation data K. Moreover, as illustrated in FIG. 5, the value of the compensation data K is set in every 15 seconds on the elapsed time T in the compensation table 39. Therefore, if the time corresponding to the elapsed time T just before starting to read the page of the documents is not existed in the compensation table 39, the nearest compensation value K is used in the compensation table 39.

As the compensation value K used in the shading compensation following the second page can also be acquired based on the basis compensation value X acquired just before starting to read the first page of the documents as described above, there is no need to read by the CCD 23 while reading each page of the image data P1. Therefore, the shading compensation can be made by acquiring the compensation data K in very short time.

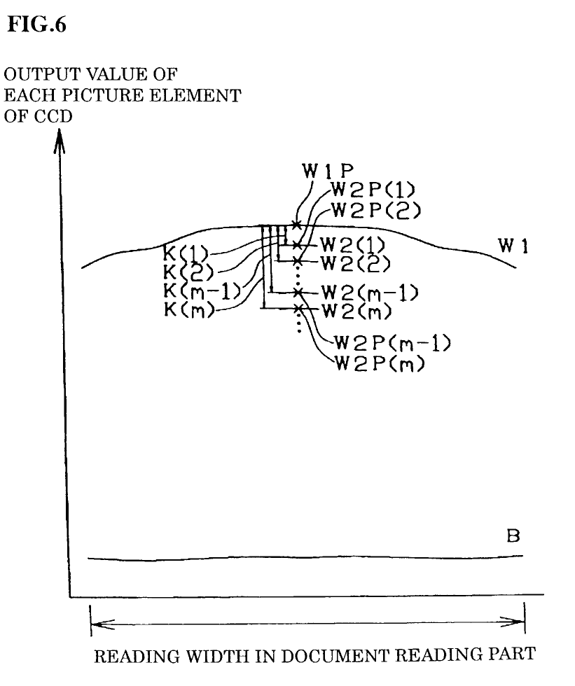

On the other hand, as illustrated in FIG. 6, the second method for acquiring the compensation data K will be described. In the second method, a difference W2P(m) W1P, which minuses the first white peak W1P from the second white peak W2P(m) of the second white basis data W2(m) (m=1, 2, 3, . . . , m−1, m, . . . ) that is acquired just before starting to read each page of the document comprising one page or a plurality of pages, is made to be a compensation data K(m) (K(m)=W2P(m)−W1P, K≦0). In other words, the second white basis data W2 is also acquired in the every time of starting to read each page following the second page, and the compensation data K(m) of each page is acquired based on the second white peak W2P(m). Thus, the compensation table 39 is not used. Then, the method of acquiring the second white peak W2P(m) and the first white peak W1P is made to be same in the case of the above first method.

Additionally, if the second white peak W2P(m) acquired just before starting to read each page is difficult to use in compensating the image data P1(m) that is read just after reading for the shading effect because of the process speed, the compensation data K(m) can be acquired by that the first white peak W2P(m−1) is taken from the second white peak W2P(m−1) of the second white basis data W2(m−1) that lies in one page before the second white basis data w2(m) acquired just before starting to read each page and the constant compensation value a is then added to the difference W2P(m−1)−W1P(K(m)=W2P(m−1)−W1P+α, K≦0).

The compensation data K found as described above is added to the first white basis data W1 in the above formula (2). Thus, the white basis data in maximizing the volume of the light source 20 can be compensated with the rise of the temperature of the light source 20. Therefore, the image data P1 can be compensated for the shading effect suitably correspond to the light volume just before starting to reading each page of the documents, reflecting the reduction of the volume of the light source 20.

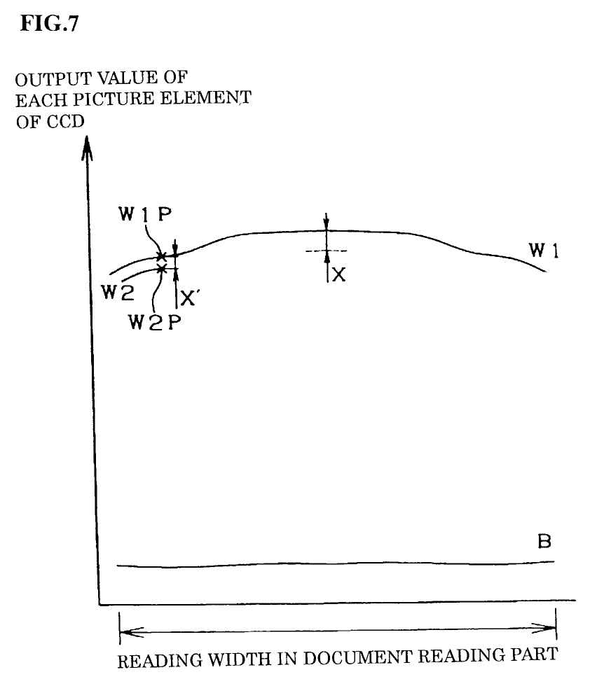

In addition, in the above embodiment, the second white basis data W2 is acquired from the output value of each picture element in a certain range that the curve of the output value is almost horizontal in the vicinity of the center of the reading width in the document reading unit 3. However, because of the configuration structure of the document reading unit 3, it is difficult to acquire the second white basis data W2, and the second white basis data W2 may be acquired only from the output of each picture element in the vicinity of the both ends part of the reading width. In such a case, as illustrated in FIG. 7, it is preferably that a basis compensation value X′ is found based on the second white peak W2P of the second white basis data W2 in the vicinity of the both ends of the reading width and the first peak W1P of the output of each picture element in a certain range corresponding to the range that is read for acquiring the second white basis data W2 (X′=W2P−W1P, X′≦0), however the value X′ tends to be smaller compared with the basis compensation value X calculated by acquiring the second white basis data W2 from the output value of each picture element in the vicinity of the center of the reading width in the document reading unit 3 as described above (X′<X).

Therefore, if the basis compensation value X′ is made to be the compensation data K in the vicinity of the center of reading width, the image in this region may be darkened without compensating for the shading effect properly. Consequently, it is preferable that the compensation data K is found by multiplying a predetermined compensation factor β to the basis compensation value X′ in order for the compensation data K on the picture element in the vicinity of the center of the reading width to be the proper value in such a case (K=β×X′(=X)). Here, the compensation factor β is regarded as the same value as the one that divides the basis compensation value X that is calculated by acquiring the second white basis data W2 from the output of each picture element in the vicinity of the center of the reading width, by the basis compensation value X′ in this case (β=X/X′), and it is found in advance by the experiment.

Moreover, a first white mean W1A may be used instead of the first peak W1P and a second white mean W2A may be also used instead of the second white peak W2P, for acquiring the compensation data K. In this case, the first method of acquiring the compensation data K as described above is that the compensation data K is acquired by regarding the difference W2A−W1A that minuses the first white mean W1A, from the second white mean W2A acquired just before starting to read the first page of the document as the basis compensation value X (X=W2A−W1A, X ≦0).

Furthermore, in the second method of acquiring the compensation data K as described above, the difference W2A(m)−W1A that minuses the first white value W1A from the second white mean W2A(m) (m=1, 2, 3, . . . , m−1, m, . . . ) is acquired as the compensation data K(m) (K(m)=W2A(m)−W1A, K≦0).

As described above, when the second white mean W2A and the first white mean W1A are adopted instead of the second peak W2P and the first white peak W1P, the time required for the shading compensation process becomes slightly longer, however the correct compensation may be implemented without suffering from noise effects.

What is claimed is:

1. An image reading apparatus comprising:
a light source;
a white basis plate;
a first white basis data acquisition device that acquires a white basis data W1 by reading the white basis plate, with the light source that is fully cooled on;
a second white basis data acquisition device that acquires a white basis data W2 by reading the white basis plate with the light source on just before starting to read a first page of a document;
a compensation data acquisition device that acquires a compensation data K, based on the white basis data W1 and the white basis data W2; and, a shading compensation device that outputs compensation image data P2 by compensating for a shading effect of each page of image data P1 that is acquired by reading each page of the document, based on the black basis data B, the white basis data W1, and the compensation data K acquired in advance.

2. The image reading apparatus as in claim 1, wherein the compensation data K is acquired based on a peak W1P of the white basis data W1 and a peak W2P of the white basis data W2.

3. The image reading apparatus as in claim 2 further comprising a compensation table that sets a relationship with the compensation data K corresponding to a basis compensation value X, wherein the compensation data acquisition device acquires the compensation data K based on the compensation table and the basis compensation value X that is acquired by subtracting the white peak W2P from the white peak W1P.

4. The image reading apparatus as in claim 3, wherein the compensation table sets the relationship between an elapsed time from starting to light the light source and the value of the compensation data K, and the compensation data acquisition device acquires the compensation data K based on the elapsed time T just before starting to read each page of the document and the compensation table.

5. The image reading apparatus as in claim 4, wherein the compensation data acquisition device acquires the compensation data K in the nearest time from the compensation table if the time corresponding to the elapsed time T does not exist in the compensation table.

6. The image reading apparatus as in claim 1, wherein the first white basis data acquisition device makes a mean of each picture element of the white basis data W1 by reading the white basis plate more than once with the light that is fully cooled on.

7. The image reading apparatus as in claim 1, wherein the first white basis data acquisition device reads the white basis plate with the light that is fully cooled throughout the entire reading width.

8. The image reading apparatus as in claim 1, wherein the second white basis data acquisition device reads the white basis plate in a certain range of the entire reading width.

9. The image reading apparatus as in claim 8, wherein the certain range is a central part of the entire reading width.

10. The image reading apparatus as in claim 8, wherein the compensation data acquisition device compensates the compensation data K in a certain range of the picture elements more according to a ratio of the white basis data W1 and the black basis data B in each picture element, and it is made to be the compensation data of each picture element other than the certain range.

11. The image reading apparatus as in claim 1, wherein the light source is a cold cathode tube.

12. The image reading apparatus as in claim 1, wherein a shading compensation device compensates for the shading effect according to the following formula:
P2=(P1−B)/{(W1+K)−B}×(2ⁿ−1)
the code n is a process bit number, and the code K is a value less than zero.

13. The image reading apparatus as in claim 2, wherein the mean W1A of the white basis data W1 is used instead of the white peak W1P, and the mean W2A of the white basis data W2 is used instead of the white peak W2P.

14. An image reading apparatus comprising:
a light source;
a white basis plate;
a first white basis data acquisition device that acquires a white basis data W1 by reading the white basis plate in the state of lighting the light source that is fully cooled;
a second white basis data acquisition device that acquires a white basis data W2 by reading the white basis data with the light source on just before starting to read each page of a document;
a compensation data acquisition device that acquires a compensation data K based on the white basis data W1 and the white basis data W2; and
a shading compensation device that outputs a compensation image data P2 by implementing the shading compensation to an image data of each page that is acquired by reading each page of the document based on a black basis data B, the white basis data W1, and the compensation data K acquired in advance.

15. The image reading apparatus as in claim 14, wherein the compensation data acquisition device respectively acquires the compensation data K based on a peak W1P of the white basis data W1 and a peak W2P of the white basis data W2.

16. The image reading apparatus as in claim 15, wherein the compensation data acquisition device makes a difference W, which subtracts the peak W1P from the peak W2P, to the compensation data K.

17. The image reading apparatus as in claim 14, wherein the first white basis data acquisition device reads the white basis plate in the state of lighting the light source that is fully cooled more than once, and a mean value on each picture element is made to be the white basis data W1.

18. The image reading apparatus as in claim 17, wherein the first white basis data acquisition device reads the white basis plate with the light source that is fully cooled on throughout the entire reading width.

19. The image reading apparatus as in claim 14, wherein the second white basis data acquisition device reads the white basis plate in a certain range of the entire reading width.

20. The image reading apparatus as in claim 19, wherein the certain range is a central part of the entire reading width.

21. The image reading apparatus as in claim 19, wherein the compensation data acquisition device compensates the compensation data K in the certain range of the picture element according to a ratio of the first white basis data W1 in each picture element and a black basis data B in each picture element more, and it is made to be the compensation data of each picture element other than the certain range.

22. The image reading apparatus as in claim 14, wherein the light source is a cold cathode.

23. The image reading apparatus as in claim 14, wherein the shading compensation device compensates for the shading effect according to the following formula.
P2=(P1−B)/{(W1+K)−B}×(2ⁿ−1)
where the code n is a process bit number, and the code K is a value less than zero.

24. The image reading apparatus as in claim 15, wherein a mean W1A of the white basis data W1 is used instead of the peak W1P, and a mean W2A of the white basis data W2 is used instead of the peak W2.

25. An image reading apparatus characterized in that the compensation data is acquired based on the white basis data acquired by reading the white basis plate just before starting to read documents, and the shading compensation is made to the image data of each page that is acquired by reading documents, using the compensation data.
